(19) United States
(12) Patent Application Publication
(10) Pub. No.: US 2004/0183387 A1
(43) Pub. Date: Sep. 23, 2004

(54) Permanent electro magnetic motor

(76) Inventor: James Alfred Moe, White Bear Lake, MN (US)

Correspondence Address: James A. Moe, 4803 Carolyn Lane, White Bear Lake, MN, 55110, US

(21) Appl. No.: 10/394,901

(22) Filed: Mar. 21, 2003

(51) Int. Cl. H02K 21/00; H02K 23/04; H02K 53/00

(52) U.S. Cl. 310/152; 74/DIG. 9

(57) ABSTRACT

This invention relates to a true permanent electro magnetic motor, with no electrical winding, coils or electrical circuitry of any kind that is attached to any of the permanent magnets in this invention. With two large round north and south bevel magnet wheels facing each other on a vertical center axle, Placing four sets of square block magnets into a magnet cross over bar that is placed between the two large round north and south bevel wheel magnets, the magnet cross over bar requiring very little energy will flip up 45 degrees on each one half a turn, activated by one of two small solenoids, that is attached to a magnet cross over bar, changing the magnetic polarity in the magnet cross over bar, from a north to south magnetic polarity or from a south to north magnetic polarity, as the two large round bevel wheel magnets move into the side two energy quarters of each of the two large bevel magnet wheels, the magnet cross over bear that has just flip up, will move up and down on the bevel angle edge of the north and south large bevel wheel magnets, driving the two large bevel wheel magnets around a center axle, being used as power fly wheels, running at a constant R. P. M. creating lots of workable energy, tied into an electrical generator.

### BACKGROUND OF THE INVENTION

### FIELD OF INVENTIONS

This invention relates to a different kind of a permanent electro magnetic motor. It will require a new understanding how this permanent electro magnetic motor works. It is an open face permanent magnetic motor, that has no out side field cores or electrical winding to any of its permanent magnets in this invention. So called other permanent magnet-motors have permanent magnets in the outer field cores with electrical windings, or have permanent magnets in a center rotor with electrical coils driving the center rotor around.

This open face permanent magnetic motor is being constructed with two large bevel north and south magnet wheels facing each other on a vertical center axle, with two sets of square block magnets placed into the top and bottom of both north and south large bevel wheel magnets. These block magnets, called switch block magnets, will allow magnets placed into a magnet cross over bar, that is placed in between the two large north and south bevel wheel magnets, will allowing both large north and south bevel wheel magnets to move freely to the top and bottom wheel center line, next to the magnet cross over bar. From one of two small solenoids, the magnet cross over bar will flip up 45 degrees, changing the magnetic polarity in the magnet cross over bar, having equal amount of energy going through the top and bottom of the switch block magnets, moving the two large bevel magnet wheels into the two energy side quarters where the magnet in the magnet cross over bar will start to move, up and down, pushing and pulling on the bevel angle edges in each of the two large bevel wheel magnets, on each half a turn, moving the two large north and south bevel magnet wheels around a center axle with energy.

By designing this new type of a permanent electro magnetic motor, with having two sets of square block magnets, with four magnets in each set of magnet block, one being a north center block magnet and one being a south center block magnet, having changed the magnetic polarity side in a magnet, to be on each one quarter side in a square block magnet. They are not like a normal magnet where the north and south magnetic sides of a magnet is on opposite sides. These north and south center block magnets in this invention that a are on each one quarter side of a block magnet, are placed into a magnet cross over bar, that will flip 45 degrees one way or the other, changing the magnetic polarity in a magnet cross over bar on each half a turn. All other known permanent magnets have to turn 180 degrees one way or the other to change the magnetic polarity in a magnet. By changing a permanent magnetic polarity around 180 degrees in a magnet, it is impossible to make this type of a permanent magnetic motor to work, it has to pull away from the pull pressure in the magnet and it has to flip 180 degrees changing direction going into the push pressure side of a magnet, having no equal energy force, when changing magnetic polarity, ending up with a zero or minus force of workable energy in a magnetic field.

In this new invention by designing permanent magnets, that are used in this electro magnetic motor, that will solve the age old problem, making a permanent magnet to work.

In this new type of a permanent electro magnetic motor, by changing magnetic fields around in square block magnet to be on each one quarter side of a square block magnet, allowing only 45 degrees movement to change polarity in a magnet field, along with two north and south large round bevel wheel magnets, with switch block magnets placed in them, having equal amount of magnetic energy force on a magnet cross over bar, when changing the magnetic polarity on each half a turn, as the square block magnets in a magnet cross over bar, move up and down the bevel edges of the large bevel wheel magnets, to make this new magnetic motor work, as it move around a center axle.

Compared to a conventional electric motor, where it takes more energy for more power that will pull constantly around an armature, and also the loss of energy from heat build up as it runs for long periods of time.

Prior known patent is U.S. Pat. No. 4559, 463 issued Dec. 17, 1985, to H. Kobayashi, a magnet motor of this type, being a permanent magnet type rotary electrical machine, has permanent magnets in an outer field core, with a double cage winding, with permanent magnets attached to a center rotor, that turning against an uneven outer field core, using more electrical energy for more workable power. With many precision parts and holding extreme tolerance, trying to minimizes leakage of magnetic flux to other permanent magnets that will cause less out put of energy.

In my invention, being a true permanent magnet motor, with no electrical energy being induced to any of the permanent magnets in this invention, it will take the same amount of energy to run, whether it is working or not working, having no heat loss, or leakage of magnet flux to other magnets, running for long periods of time. All the power is in the permanent magnets in themselves, achieving more power with bigger, larger and heavier wheel magnets, with extra energy being developed from the two large north and south bevel wheel magnets, used as flywheel power in this invention, which will be turning at a constant R. P. M.

### BRIEF SUMMARY OF THE INVENTION

The present invention provides a simplified permanent electro magnetic motor, can be built to any size to be locked into a generator to create electricity, that has a small starter motor to start this permanent magnet motor turning. With two large round bevel magnet wheels placed on a vertical center rod axle, placing two sets of block magnets into both large north and south bevel magnet wheels, called switch block magnets, at the bottom and top of each wheel, that will allow the magnets that are placed into a magnet cross over bar, that is placed between the two large bevel wheel magnets, to have equal amount magnetic pressure when the magnet cross over bar will be flipping up 45 degrees from one of the two small solenoids which is attached to one side of a magnet cross over bar.

As the two large north and south bevel magnet wheels that will be moving out of a top and bottom wheel centerline, moving into the side two energy quarters, where the magnet in the magnet cross over bar, will start pushing and pulling up and down on the bevel angle edges of the two large bevel wheel magnets, giving the two large bevel magnet wheels energy power on each one half a turn. By using the two large bevel magnet wheels as power flywheels producing extra energy, as the wheels move around a center axle.

Compared to a conventional permanent magnet electric motor having many electrical parts, and electrical winding with constantly shutting on and off to make one full revolution, requiring more energy for more workable power.

The present invention has very few parts, using the same amount of energy whether is working or not working, with two small solenoids, requiring one of the solenoids to pull up 45 degrees on each on each one half a turn, that is connected to a non restrictive magnet cross over bar, that will turn the two large magnet wheels into flywheels, to turn at a constant R. P. M. creating lots of workable energy.

### BRIEF DESCRIPTION OF THE DRAWING WITH THERE STRUCTURES

The present invention and its many features and advantages will be more apparent after reading the following detailed description which refers to the accompanying drawing wherein all S. will stand for (south magnets) and all N. will stand for (north magnets) to illustrate the working parts in this invention.

FIG. 1 of sheet 1

Is a detailed front view of a permanent magnetic motor constructed according to the present invention. With two large north and south bevel round magnet wheels, with a front view of a magnet cross over bar, with the electrical switches and solenoids, a timing block cam, a pulley tied to an electrical generator and a gear wheel with a starter motor that is tied to the bottom of the center axle and a center axle that is riding on a center point of a nylon screw block head.

FIG. 2 of sheet 2

Is a side view of the present invention, having a series of magnets displaced from there original arrangement locations; with two large round north and south bevel magnet wheels, a side view of a magnet cross over bar along with the electrical switches and solenoids, a timing block cam, a wheel pulley that is tied to the bottom of the center axle and a center axle that is riding on a center point of a nylon screw block head.

FIG. 3 of Sheet 3

Showing the end view of a square magnet block, being one half inch square, that allows energy of a north and south side magnet to be on each one-quarter sides of a square block magnet, instead of like a normal magnet having a north and south on opposite sides. These north and south energy square block arrangements in this invention are called north and south L shaped magnet pressure legs.

Having four magnets that are assembled in a square block, each of the magnets having a north and south side, when these four magnets are assembled 90 degrees from one another, it will have three (S) south side magnets in the center of the block, and one (N) north side magnet in the center of the block, showing one north and one south L shaped pressure legs, located on each one quarter side in the same end of a square block magnet, showing with arrows, the other two quarter sides of the magnet blocks are equal, both having a north and south on each side, that will have equal magnetic pressure. This block of magnets is called a south center block magnet. It is one of two block magnets that will be inserted in each of the two large bevel wheel magnets.

In FIG. 4 of sheet 3. Showing the end view.

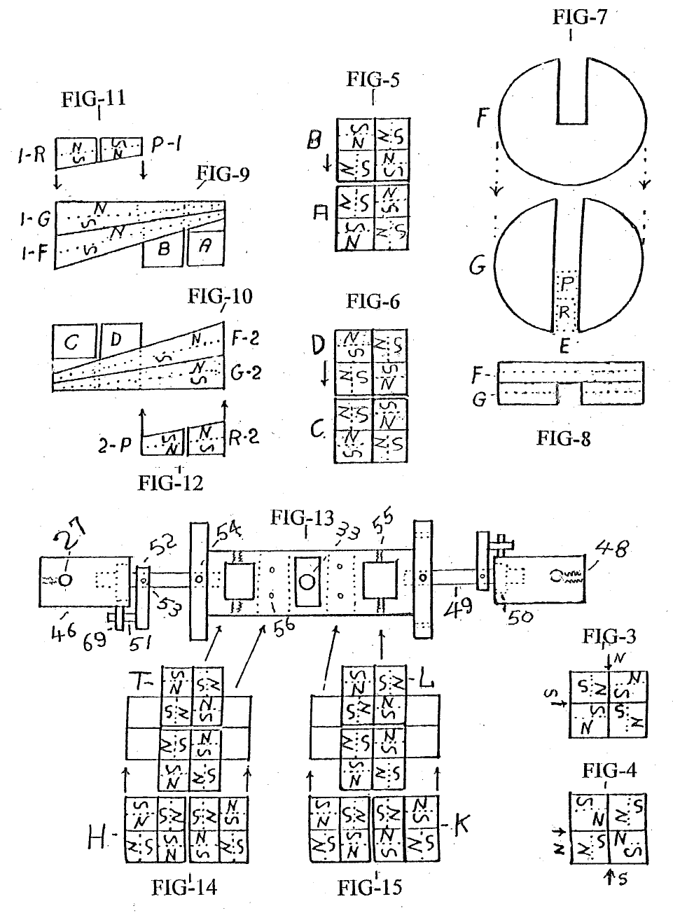

Four magnets that are assembled in a square block, similar to that of FIG. 3 of sheet 3 except for when the four magnet blocks that are assembled, it will have three north (N) side magnets in the center of the block, and one south (S) side magnet in the center of the block, located on each one quarter side in a square block magnet, this block of magnets, is called a north center block magnet. It is one of the two block magnets that will be inserted in each of the two large bevel wheel magnets.

FIG. 5 of sheet 3.

Showing the front view of two block magnets, block A is a south center block magnet and block B is a north center block magnet. Block B is placed in the back of magnet block A, both block A and B magnets are placed in a top south facing bevel wheel magnet as seen in FIG. 9. of sheet 3. These two block magnets, being called switch block magnets, which will have equal force to different magnet blocks, that are placed into a magnet cross over bar of FIG. 13, allowing the magnets to move freely, from one side of the magnet wheel to the other side of a magnet wheel.

FIG. 6 of sheet 3. Showing the front view

Two magnet blocks similar to FIG. 5 of sheet 3, except for the magnets being turned around, going from front to back, magnet block C having a north center, is placed in the front of magnet block D. with a south center, both C and D magnet blocks are placed in the bottom of the north facing bevel magnet wheel, as seen in FIG. 10 of sheet 3. These two block magnets, being called switch block magnets which will have equal force to different magnet blocks, that are placed into a magnet cross over bar of FIG. 13, allowing the magnets to move freely from one side of the magnet wheel to the other side of the magnet wheel.

FIG. 7 of sheet 3.

Showing the top view of one set of the two large bevel wheel magnets F and G being two and a half inches in diameter and one quarter inch in width, where magnet wheel F is being cut on each side of the centerline, equaling twice the width of the magnet wheel, with equal portion of magnetic material taken out, to the center of the magnet wheel, magnet wheel G of FIG. 7 is cut on each side of the centerline, equaling twice the width of the magnet wheel, with equal portion of magnetic material taken out, all the way across the magnet wheel, where F magnet wheel is placed on top of G magnet wheel, also showing in a side view in FIGS. 9 and 10, where F and G wheels are placed together.

FIG. 8 of sheet 3

Showing a front view of FIG. 7 of F and G wheels, where F wheel is placed on top of G wheel, in FIG. 8 is showing a front view of two wheels of F and G, where R and P magnet in being placed in the bottom wheel of FIG. G also showing in FIGS. 9 and 10 of sheet 3, where R and P magnet of FIGS. 11 and 12 will be inserted into both large wheel magnets, where P magnet side will have equal magnetic pressure to the center of magnet wheel F in each of the two large north and south bevel wheel magnets, as most clearly shown in FIGS. 9 and 10 of sheet 3, where P magnet side will have equal pressure to a bottom side of magnet wheel F, that will allow a dead center spot on the top of F magnet wheel that will allow the two large north and south bevel wheel magnets to move freely up to the magnet cross over bar, being called a top and bottom wheel centerline movement, showing in FIG. 16 of sheet 1.

FIGS. 9 and 10 of sheet 3

Showing in both sets of the large north and south large round bevel magnet wheels, showing magnet blocks of FIGS. 5 and 6 and 11 and 12 of sheet 3, are placed into each one of the large north and south large round bevel magnet wheels.

Each set of north and south large bevel wheel magnets in FIGS. 9 and 10, are being cut across the diameter of each wheel on a bevel angle from the top of each wheel to one-quarter of the width at the bottom of each wheel.

FIGS. 11 and 12 of sheet 3

Two sets of beveled magnets of different magnetic sides, showing R and P magnet blocks when placed together, each one being one half inch long and one half inch in width, as seen in FIGS. 11 and 12 of sheet 3,both sets of magnet blocks will make circuits with one another. When placed into the two large magnet wheels in FIGS. 9 and 10 of sheet 3, P magnet sides will always be placed towards the center in each of the two large north and south large bevel wheel magnets, P magnet side being of the same magnetic side as F in FIGS. 9 and 10 of sheet 3, will always cause equal pressure to each another, leaving the center top portion of the two large magnet wheels F with zero energy to any other magnets, allowing both large north and south bevel wheel magnets to move up to the magnet cross over bar, being called the top and bottom wheel centerline, showing in FIG. 16 of sheet 1.

FIG. 13 is a magnet cross over bar of sheet 3

Is a top view of the magnet cross over bar with stop pins, on both ends, having blocks with pins to stop the movement of the cross over bar to limited travel. The two end blocks have bearings placed into them, allowing movement of the cross center axle, having space in the cross over bar to hold four sets of block magnets, and to allow a center axle to pass through the center of the magnet cross over bar, that will move up and down 45 degrees, on each half a turn.

FIGS. 14 and 15 of sheet 3

Is an end view of four sets of north and south center block magnets, two sets on each side of a center axle, placed into a magnet cross over bar, in FIG. 13 of sheet 3. Both magnets blocks in T and L of FIGS. 14 and 15 are the same in there make up, facing in different directions in the magnet cross over bar, standing up right, at each end of the magnet cross over bar in FIG. 13 of sheet 3. With each set of magnet blocks in T and L, one block is a north center magnet block and one block is a south center block magnet, will make a circuit to each other, when placed together side by side, making up a block set. Each set of magnet blocks in T and L in there four comers having L shaped pressure legs, two north and two south pressure legs, that are crisscrossing from one another.

Magnet blocks H and K in FIGS. 14 and 15 of sheet 3 are different in there make up, backward to T and L above, laying side ways in the magnet cross over bar next to a center axle. Both magnet blocks H and K are the same in their make up. One block is a north center magnet and one block is a south center magnet, will make a circuit with each other when placed together, side by side, making up a block set of magnets, each set of magnets H and K in there four comers, having L shaped pressure legs, two north and two south pressure legs, are crisscrossing from one another. These magnets T, L, H, and K that are in the magnet cross over bar will flip through the top and bottom of the switch block magnets, and will move into the side two energy quarters of the large bevel wheel magnets, and will move up and down the bevel edges of both large north and south bevel wheel magnets, pushing and pulling turning the two large magnet wheels around a center axle, on each one half turn.

FIG. 16 of sheet 1

Is showing a top view of one of the large magnet wheels that is divided up into four quarters, where the magnet cross over bar is moving up and down through the top and bottom quarter of the wheel, with equal amount of energy. The two side energy quarters of the wheel, the magnet cross over bar, will be pushing and pulling with force on the incline of both large north and south bevel wheel magnets.

### DETAILED DESCRIPTION

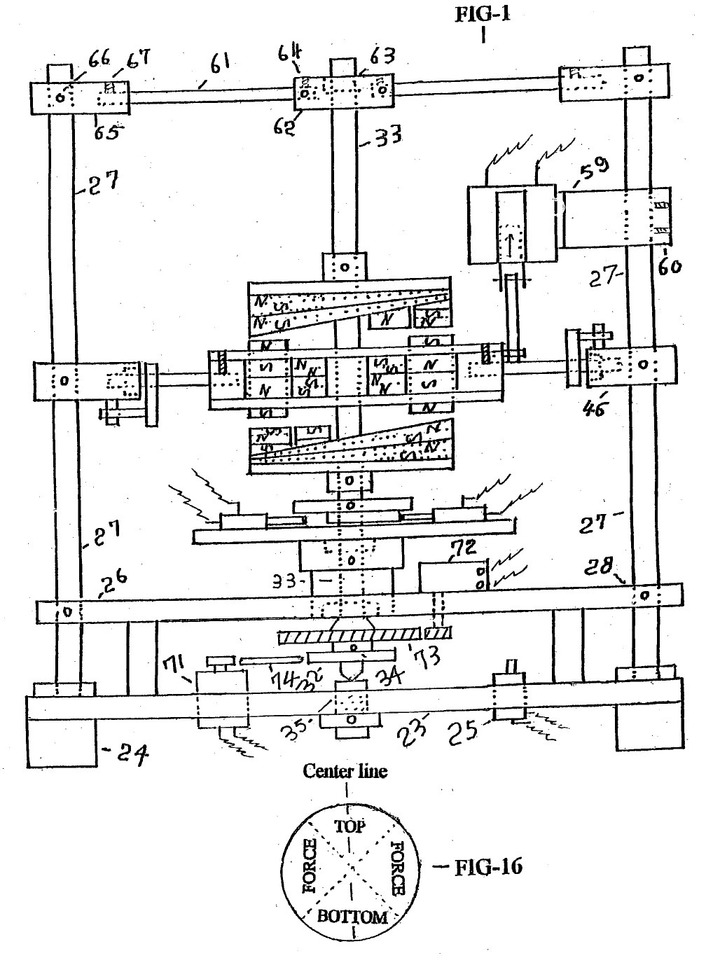

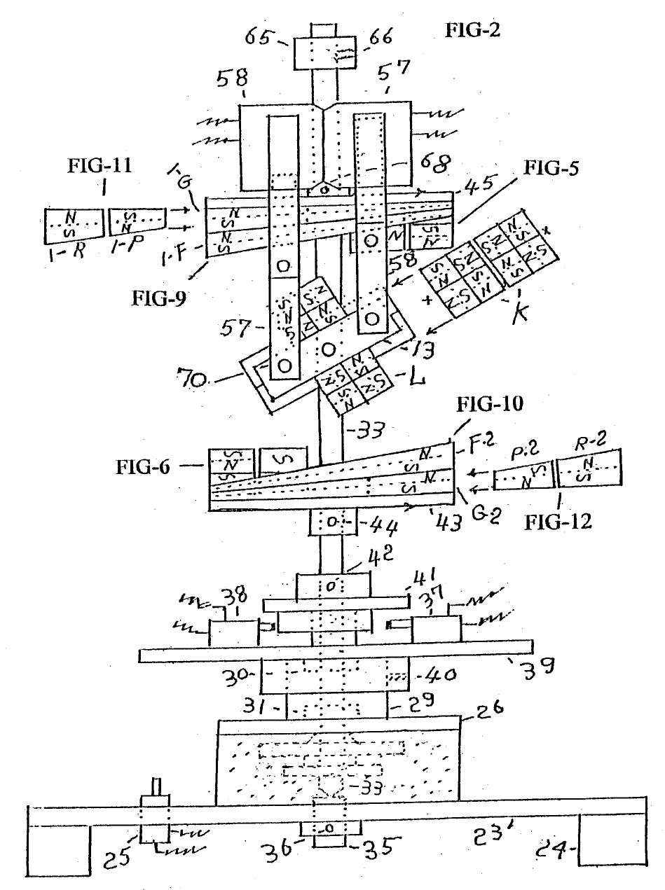

Referring now to the drawing that is shown in FIG. 1 of sheet 1. A model of a permanent electro magnetic motor constructed with permanent magnet which can be built of any desired size, comprises of a small starter motor 72 that is locked into a center gear wheel 73, that is attached to the center axle 33 and a wheel pulley 32 with a locking pin 34 that will lock a wheel pulley unto the center axle 33, a belt 74 going from the wheel pulley to electrical generator 71, a base plate 23 attached is a set of legs 24 and a electrical switch 25 with a rod plate holder 26, to hold two stand up rods 27 in place with a locking pin 28. As most clearly shown in FIG. 2 of sheet 2 is a center block 29 to be pressed into the rod plate holder 26, with a set of bearings 30 and 31 at each end of block 29, the bottom of the center axle 33 riding on a nylon screw head 35 for less friction, block 35 that is passing though the base plate 23, with a lock pin 36, having a set of micro switches 37 and 38 tied into a round holding plate 39, locked on to the block 29, with locking pin 40, to hold a round plate 39 in different positions, with a timing block 41 with locking pin 42, tied onto the center axle 33, to engage one of the two micro switches 37 or 38 as the center axle is turning. In FIG. 10 of sheets 2 the bottom wheel magnet holder 43, with a pin 44 tied into the center axle 33, with a magnet that will be placed into the bottom on the magnet holder 43, in FIG. 10 of sheet 3 is a set of round magnet wheels, 2-F and 1-G, each magnet wheel is having a north and south magnetic side, each magnet is one quarter inch in width and two and one half inches in diameter, both magnet wheels are being cut at the same bevel angle, being cut across the diameter of the magnet wheels, in FIG. 10 of sheet 3 from the top edge of the magnet wheel to one sixteenth of a inch at the bottom edge of the magnet wheels, In FIGS. 7 and 8 of sheet 3 is a top and front view being the same magnets as seen in FIG. 10, of sheets 2 and 3. Showing in FIG. 7 of sheet 3 where 2-F magnet wheel is being cut one quarter inch on each side from a center line of the magnet wheel, starting at the bottom thin side of the wheel magnet, up to the center of the wheel, with equal portion of the magnetic material taken out, leaving a one half inch opening. Magnet wheel 2-G is being cut in half, starting at the bottom of the thin side of the magnetic wheel, taken out one quarter inch from each side of the center line of the magnet wheel, all the way across the wheel, leaving two semi equal split half magnets. Showing in FIG. 10 of sheet 2 and 3, where both wheel magnets are placed together, where the semi north facing split wheel magnet G-2 is placed into the bottom of the set, and the north facing 2-F magnet wheel is placed on top in the set, showing a north facing set of magnet wheels placed into the bottom wheel holder 43.

In FIG. 9 of sheet 2 the top wheel magnet holder 45 with locking pin 68 tied to the center axle 33, with magnet that will be placed into the top on the magnet holder 45 is a set of round magnets 1-F and 1-G of sheets 2 and 3 each of the two magnet wheels in each set having a north and south magnet side, each magnet is one quarter inch in width and two an one half inches in diameter; both magnet wheels are being cut at the same bevel angle, being cut across the diameter of the magnet wheels from the top edge of the magnet wheel to one sixteenth of an inch at the bottom edge of the magnet wheel, In FIGS. 7 and 8 of sheet 3 is a top and front view being the same magnetic side as seen in FIG. 9, of sheets 2 and 3. Showing in FIG. 7 of sheet 3 where 1-F magnet wheel is being cut one quarter inch on each side from a center line, to the center in the magnet wheel, starting at the bottom of the thin side of the magnet wheel, up to the center of the wheel, with equal portion of the magnetic material taken out, leaving a one half inch opening. Magnet wheel 1-G is being cut in half, starting at the bottom of the thin side of the magnet wheel, taken out one quarter inch from each side of the center line of the magnet wheel, leaving a half inch gap between the two semi split half magnets. Showing in FIG. 9 of sheet 2 and 3 both wheel magnets are placed together, where the semi south facing bottom split magnet wheel 1-G is placed into the bottom of the set, and south facing 1-F magnet wheel is place on the top in the set, showing a south facing set of magnet wheels placed into the top wheel holder 45.

As most clearly shown in FIGS. 3 and 4 of sheet 3, is an end view of two square magnet blocks, being one half inch square, that allows energy of north and south magnet to be on each one quarter sides of a magnet block, instead of like a normal magnet having a north and south on opposite side. These north and south energy magnet block arrangements are called north and south magnetic pressure line leg magnets. In FIG. 3 Showing an end view of four magnets that are assembled in a square block, each magnet in this block of magnets of four, being one quarter inch square and a half inch long, each one of the magnets having a north and south side, when these four magnets are assembled 90 degrees from one another, it will have three (S) south side magnets in the center of the block, and one (N) north side magnet in the center of the block, showing one north and one south L shape pressure line leg, located on each one quarter side of a square magnet block, the other two quarter sides of the magnet block having equal magnetic pressure. This block of magnets is one of two that will be placed into the two large north and south bevel wheel magnets in FIGS. 9 and 10 in the bottom thin bevel end, with a half-inch opening This is called a south center block magnet.

In FIG. 4 Showing an end view of four magnets that are assembled in a square block, each magnet in this magnet block of four, being one quarter inch square and a half inch long, each one of the magnets having a north and south side, when these four magnets are assembled 90 degrees from one another, it will have three (N) north side magnets in the center of the block and one (S) south side magnets in the center of the block, showing one north and one south L shape magnetic pressure line leg, located on each one quarter side in the same end of a square block magnet, the other two quarter sides of the magnet block having equal magnetic pressure. This block of magnets is one of two block magnets that will be placed into the two large bevel wheel magnets of FIG. 9 and 10 at the bottom thin bevel end, of the two large north and south wheel magnets with the half-inch opening. This is called a north center block magnet.

As most clearly shown in FIGS. 3 and 4 of sheet 3, is an end view, where both these block magnets that are showing in FIG. 5 are assembled together, these two block magnets will make up a set of magnet blocks, when placed together end to end, showing B block magnet is a north center magnet block, is placed behind A block magnet being a south center magnet block, showing L shaped magnetic pressure lines, going in different direction on the same top side, these two block magnets will be placed into the thin bevel bottom side of the magnet wheels of FIG. 9 as seen in sheets 2 and 3.

As most clearly shown in FIGS. 3 and 4 of sheet 3 is an end view, where both these block magnets that are showing in FIG. 6 are assembled together, these two block magnets will make up a set of magnet blocks, when placed together end to end, showing D a south center magnet block, is placed behind C a north center block magnet, showing L shaped magnetic pressure lines, going in different directions on the same top sides, these two block magnets will be placed into the thin bevel bottom side of the magnet wheels of FIG. 10 as seen in sheets 2 and 3.

As most clearly shown in FIGS. 11 and 12 of sheets 2 and 3 is a side view of the second set of magnet blocks, that are placed into the two large north and south bevel magnet wheels of FIGS. 9 and 10 of sheets 2 and 3, the first set of bevel square block magnets will be called 1-R and 1-P, the second set of bevel square magnet blocks will be called 2-R and 2-P both set of magnet blocks R and P being divided into two equal halves, each being one half inch in length, and one half inch in width, that is being cut at the same bevel angle, as in each of the two large north and south bevel magnet wheels.

In FIG. 12 of sheet 2, both magnets blocks 2-R and 2-P being a north and south square block magnet, when placed together will be making a circuit to one another, 2-P is a south facing magnet block and 2-R is a north facing magnet block, 2-P magnet in the set will be placed into the center of the large bevel north facing magnet wheel of FIG. 10 of sheet 2, placed into the top heavy end into the center of the semi split half magnet wheel of 2-G.

In FIG. 11 of sheet 2 both magnet blocks 1-R and 1-P being a north and south square block magnet, when placed together will be making a circuit to one another, 1-P is a north facing magnet block and 1-R is a south facing magnet block, 1-P in the set will be placed into the center of the large bevel south facing magnet wheel of FIG. 9 of sheet 2, placed into the top heavy end into the center of the semi split half magnet wheel of 1-G.

As most clearly shown in FIGS. 9 and 10 of sheets 2 and 3 were R and P block magnets of FIGS. 11 and 12 are entering into the center of magnet wheel G, where 1 P and 2 p magnet blocks will always be placed into the center of the wheel, where magnet block P will have the same magnetic pressure side as both N and S magnet wheels F, causing a dead center spot, in each of the north and south large bevel magnet wheels in FIGS. 9 and 10, of sheet 3. The other half of R and P magnet blocks, where R magnet block will be picking up energy from the top of wheel magnet F as both magnet R and F are making circuit to one another. When the two large bevel magnet wheels are moving towards the magnet cross over bar 13 of sheet 2 moving through the dead center spots at the top of each magnet wheels, and through the switch block magnets at the bottom of each wheels, will be entering into the top and bottom wheel center-line in FIG. 16 of sheet 1. The magnets in the magnet cross over bar of FIG. 13 of sheet 2 will flip up 45 degrees from one of the two solenoids in FIG. 57 or 58 of sheet 2, as both large bevel magnet wheels will start moving into the two energy side quarters, where magnets that are in a magnet cross over bar that are on each side of the two large north and south bevel wheel magnets, will start to push down on each side on the heavy bevel edges on the two large north and south bevel wheel magnets, and the pull magnets in the magnet cross over bar on each side of the two large north and south bevel wheel magnets will start to pull up on each side on the heavy bevel edges on the two large bevel wheel magnets, causing the two large magnet wheels to turn around on a center axle, on each half a turn.

As most clearly shown in FIG. 13 of sheets 2 and 3, the magnet cross over bar 13 that is placed between the two large center wheel magnets 43 and 45, having a set of end blocks 46 with hole on the end to allow a stand up rod 27 to pass through, with locking pin 48 to lock block 46 unto stand up rod 27, a set of cross center rod axles 49 in the cross over bar 13, will enter into bearings 50 on each end of the end blocks 46, a pin 69 which has been pressed into the end block 46, which has a set of stop pins 51, one on each end of the end blocks 46 to stop the movement of cam bar 52 that has a locking pin 53, that is locked onto cross center axle 49, the other end of the two cross center axles 49 will enter the magnet cross over bar 13, and it will be locked in to pin 54.

As most clearly shown in FIGS. 14 and 15 of sheet 3, showing a front view, of four sets of square block magnets, with four magnets in each block, each magnet in each block are one half inch long and one quarter inch square, four magnets in each block, making a square block magnet, one half by one half inches square. Showing each block magnets seen in FIGS. 3 and 4 of sheet 3, that are place together in sets, will be placed into a magnet cross over bar of FIG. 13, of sheet 3. In FIG. 14-T Showing a set of magnet blocks that will be standing up on the left hand side of the magnet cross over bar 13, of sheet 3, the top block magnet being a north center block magnet, the bottom block magnet being a south center block magnet, placed together side by side, making a circuit to one another, showing a L shaped magnetic pressure leg on all four comers, two north and two south pressure legs, that are crisscrossing from one another with two sets of locking pins 55 to hold the magnets in place.

In FIG. 15 L Showing a set of magnets that will be standing up on the right hand side of the magnet cross over bar 13, of sheet 3, the top block magnet being a north center block magnet, the bottom block magnet being a south center block magnet, placed together side by side, making a circuit to one another, showing a L shaped magnetic pressure leg on all four comers, two north and two south pressure legs, that are crisscrossing from one another with two sets of locking pins 55 to hold a set of block magnets in place.

In FIG. 14-H. the magnets are laying on there side in the magnet cross over bar 13, of sheet 3, on the left hand side in the magnet cross over bar, the left hand magnet block being as a south center block magnet, showing the right hand block as a north center block magnet, placed together side by side, making a circuit to one another, showing a L shaped magnetic pressure leg on all four comers, two north and two south pressure legs, that are crisscrossing from one another with two sets of locking pins 56 to hold a set of block magnets in place.

In FIG. 15 K the magnets are laying on there side in the magnet cross over bar 13, of sheet 3 on the right hand side in the magnet cross over bar, showing a left hand magnet block as a south center block magnet, showing the right hand magnet block being a north center block magnet, placed together side by side, making a circuit to one another, showing a L shaped magnet pressure leg on all four comers, two north and two south pressure legs, that are crisscrossing from one another with two sets of locking pins 56 to hold a set of block magnets in place.

As most clearly shown a center axle 33 of sheet 3 passing through in the magnet cross over bar 13, as most clearly shown seen in FIGS. 1 and 2 of sheets 1 and 2, are 2 solenoids 57 and 58 that are tied into a block 59, which has a standup rod 27 going through the block with locking pin 60, to lock the block 59 to the stand up rod 27, the two solenoids 57 and 58 activating arms, that are tied into the end of the magnet cross over bar 13, with lock pins 70. As most clearly shown in FIG. 1 of sheet 1 the two cross center axle 61 that holds a center top block 62 with a bearing 63 that has been pressed into the block 62, that will allow a center axle 33 to pass through, block 62 that holds the cross center axle 61 with a set pin 64, the two end blocks 65, that the stand up rods 27 pass through, with a set pin 66 to hold block 65 in place, a set pin 67 is to hold the other end of the cross center axle in place.

Having thus described the present invention, various modifications may be made in the illustrated device, such as placing more than one set of large round bevel north and south magnet wheels on top of the one in this invention, with second set of magnets in a magnet cross over bars, that is placed between a second set of large round north and south bevel wheel magnets. A rod would be tied into both upper and lower set of the magnet cross over bars, which would eliminating one set of solenoids. Further it is proposed that all north and south center square block magnets in each north and south large bevel magnet wheel, can be turned around so the wheels will move in the opposite direction, or by turning around all the magnet in the magnet cross over bar around or upside down, would exchange the two large bevel north and south magnet wheels from top to bottom, or could exchange the two solenoids for two small gas motors, that would be tied to the magnet cross over bar.

Other modifications may be made in the scope of the present invention, without departing from the same, as defined by the appended claims.

1. What I claim as my invention is a model for a permanent electro magnetic motor, Constructed with permanent magnets.
Two round magnet wheel holders that will support two sets of large round bevel magnet wheels, one set being a north facing magnet wheel and one set being a south facing magnet wheel, that is facing each other on a vertical center axle.
Each set of magnet wheels is being cut on a bevel angle, from the top of each wheel to one quarter of the width at the bottom of each wheel.
In each set of the two large round bevel wheel magnets, a predetermine amount of magnetic material is taken out, on each side of a centerline, equaling twice the width of a magnet wheel.
One magnet in each set of round magnet wheels is being cut from the bottom of the thin bevel side of the magnet wheel, to the center of the wheel, one magnet in each set of round magnet wheels is being cut from the bottom of the thin bevel side of the magnet wheel, all the way across the magnet wheel, leaving two semi even split halves.
Placing a set of round magnet wheels together, one on top of one another, where the semi split magnet wheel will be on the bottom, in each of the two sets of north and south round bevel magnet wheels.
Two sets of square block magnets, with four magnets in each magnet block, one being a north center square block magnet and one being a south center square block magnet, showing an end view in each north and south block magnets with a north and south L shaped magnetic pressure line on each one quarter-sides, in the same end of a square block magnet.
Placing together a set of north and south center block magnets either front to back, or back to front, placed in to the bottom thin bevel side in each one of said north and south round bevel wheel magnets.
Two bevel sets of square block magnets, with a north and south flat side of a magnets showing, that will make a circuit to one another, placed together end to end, which will be placed into the top center of each north and south bevels semi split magnet wheels.
These two sets of block magnets, being called switch block magnets, being placed in to the top and bottom of the two large bevel wheel magnets, to help move the large bevel magnet wheel from a pull side of a magnet wheel, to push side of a magnet wheel, with equal amount of energy force from magnets, in a magnet cross over bar.
A magnet cross over bar that is placed between a said north and south large round bevel wheel magnets, means to hold the said magnet cross over bar in place, are two stand up rods mounted on each end of a platform.
Four sets of north and south center square block magnets in each set, two block magnets making up a set, are placed side by side to each other, one being a north center block magnet and one being a south center block magnet, in each set of block magnets in there four corners having a north and south L shaped magnetic pressure lines that is crises-crossing to one another.
Two sets of north and south block magnets in each set, are standing up 90 degrees vertically on each end in the magnet cross over bar,
Two sets of north and south block magnets in each set, are lying horizontal on they side on each side of a center axle, in the magnet cross over bar.
Means to operate said magnet cross over bar, are two small solenoids, placed on each side of said magnet cross over bar, to lift said magnet cross over bar 45 degrees on each half a turn, with equal amount of energy, changing the magnetic polarity in a magnet cross over bar, coming from a pull force, going into a push force, going through the top and bottom on both large bevel wheel magnets.
From one a of the two solenoids are activated by a set of micro switches, from a cam on said center axle, on each one half a turn.
A pulley and a gear wheel is attached to the bottom of said center axle, a pulley to be locked into a generator, with a gear wheel to start this electro magnetic motor turning.
A point at the bottom of said center axle, is riding on a nylon screw head for less friction.

2. What I claim as my invention is according to claim 1. A round magnet wheel holder that will support a set of large round bevel north facing wheel magnets, tied to a vertical center axle.

3. What I claim as my invention is according to claims 1 and 2. A set of said large round north facing magnet wheels,
being cut across the diameter of both magnet wheels, on a bevel angle from the top of each magnet wheel, to one quarter of the width at the bottom of each magnet wheel,
leaving both magnet wheels with a bottom bevel thin side.

4. What I claim as my invention is according to claims 1 and 3. One magnet in each set of said large round bevel north facing magnet wheels,
being cut from the bottom center of the bevel thin side of the magnet wheel, to the center of the wheel,
with magnet material taken out on each side of a centerline, equaling twice the width of the widest part of a magnet wheel.

5. What I claim as my invention is according to claims 1 and 3. One magnet in each set of said large round bevel north facing magnet wheels,
being cut from the bottom center of the bevel thin side of the magnet wheel, cut all the way across the magnet wheel,
with magnet material taken out on each side of a centerline, equaling twice the width of the widest part of a magnet wheel,
leaving a magnet wheel with two semi equal split halves.

6. What I claim as my invention is according to claims 1, 3, 4 and 5. Placing a set of said thin bevel sides of a north facing magnet wheels together,
both magnet wheels are making a circuit to one another,
where a said north facing semi split half magnet wheel would be on the bottom in a set.

7. What I claim as my invention is according to claim 1. A round magnet wheel holder that will support a set of large round bevel south facing wheel magnets,
tied to a vertical center axle.

8. What I claim as my invention is according to claims 1 and 7. A set of said large round south facing magnet wheels,
being cut across the diameter of both magnet wheels on a bevel angle,
from the top of each magnet wheels, to one-quarter of the width at the bottom of each magnet wheels,
leaving both magnet wheels with having a bottom thin side.

9. What I claim as my invention is according to claims 1 and 8. One magnet in each set of said large round bevel south facing magnet wheels,
being cut from the bottom center of the bevel thin side of the magnet wheel, to the center of the wheel,
with magnet material taken out on each side of a center line,
equaling twice the width of the widest part of a magnet wheel.

10. What I claim as my invention is according to claims 1 and 8. One magnet in each set of said large round bevel south facing magnet wheels,
being cut from the bottom center of the bevel thin side of the magnet wheel, cut all the way across the magnet wheel,
with magnet material taken out on each side of a center line,
equaling twice the width of the widest part of a magnet wheel,
leaving a magnet wheel with two equal semi split halves.

11. What I claim as my invention is according to claims 1, 8, 9 and 10. Placing a set of said thin bevel sides of a south-facing magnet wheels together,
both magnet wheels are making a circuit to one another,
where a said south-facing semi split half magnet wheel would be on the bottom in a set.

12. What I claim as my invention is according to claims 1, 2 and 7. One north facing set, of large round bevel wheel magnets
and one south facing set of large round bevel wheel magnets,
facing each other on a vertical center axle.

13. What I claim as my invention is according to claim 1. A said north center square block magnet,
showing end view of four-square magnet blocks, being assembled 90 degrees from one another,
showing three north side magnets and one south side magnet in the center of a square block magnet.

14. What I claim as my invention is according to claim 1 and 13. A said north center square block magnet,
showing an end view having a north and south L shaped magnetic pressure line,
on each one-quarter sides in the same end of a square block magnet,
magnetic pressure lines coming from the center of the square magnet block, going to an out-side corner.

15. What I claim as my invention is according to claim 1. A said south center square block magnet,
showing an end view of four-square magnets in a block, being assembled 90 degrees from one another,
showing three south side magnets and one north side magnet in the center of a square block magnet.

16. What I claim as my invention is according to claim 1 and 15. A said south center square block magnet,
showing an end view having a north and south L shaped magnetic pressure line, on each one quarter side of a square block magnet,
magnetic pressure lines coming from the center of the block magnet going to the out side corners.

17. What I claim as my invention is according to claims 1, 14 and 16. Two sets of said north and south center square block magnets, showing an end view in each set,
being placed together end to end, showing L shaped magnetic pressure lines, going in different directions on the same top side, in each set of the north and south center square block magnets,
placed into the bottom bevel thin sides of each north and south large bevel wheel magnets.

18. What I claim as my invention is according to claims 1 and 6. One bevel set of a said north and south facing square block magnets being placed together end-to-end, making a circuit to one another,
placing the south facing bevel magnet side in the set, into the top center of a north-facing semi split half magnet wheel.

19. What I claim as my invention is according to claims 1 and 11. One bevel set of said north and south facing square block magnets being placed together end-to-end, making circuit to one another,
placing the north facing bevel magnet side in the set, into the top center of a south facing semi split half magnet wheel.

20. What I claim as my invention is according to claims 1, 12, 13 and 15. A magnet cross over bar that is placed between a said north and south sets of large round bevel magnet wheels,
holding four sets of said north and south center square block magnets in each set.

21. What I claim as my invention is according to claims 14, 16 and 20 Four sets of
said north and south center square block magnets in each set, showing an end view in each of the four sets,
having a north and south L shape magnetic pressure lines in all four corners in each set, that is crisscrossing one another,
coming from the center of a north and south center block magnet in each set, going to the out side corners.

22. What I claim as my invention is according to claims 1, 20 and 21. Two sets of said north and south square center block magnets in each set,
placed together side by side, making a circuit to one another,
standing up 90 degrees vertically on each end in a said magnet cross over bars.

23. What I claim as my invention is according to claims 1, 20 and 21. Two sets of said north and south square center block magnets in each set,
placed together side by side, making a circuit to one another, lying on their sides horizontal, on each side of a said center axle, in a said magnet cross over bar.

24. What I claim as my invention is according to claim 1. A point at the bottom of
said center axle that comes to a center point,
that is riding on a flat surface of a nylon screw head block.
